(19) United States
(12) Patent Application Publication
(10) Pub. No.: US 2001/0054097 A1
(43) Pub. Date: Dec. 20, 2001

(54) Monitoring and reporting of communications line traffic information

(76) Inventor: Steven Chafe, Arlington, VA (US)

Correspondence Address: Roberts Abokhair & Mardula, LLC, 11800 Sunrise Drive, Suite 1000, Reston, VA, 20191-5302, US

(21) Appl. No.: 09/745,117

(22) Filed: Dec. 21, 2000

Related U.S. Application Data
(60) Provisional application No. 60/171,415, filed on Dec. 21, 1999.

(51) Int. Cl. G06F 15/16; G06F 15/173

(52) U.S. Cl. 709/224; 709/203

(57) ABSTRACT

Graphical views of data are provided on a near real time basis. Providing graphical representations of estimated resource utilization calculations on a near real time basis for review by the subscriber is very useful because it avoids the problem of not being able to make useful sense of a true real time utilization display due the bursty nature of such data streams. The near real time display is also advantageous over the conventional database formats that do not provide data on a timely basis and that place a substantial search and processing burden on the subscriber seeking to view the data. A display is provided in near real time that is based on statistical analysis of an appropriate time sample and that is then promptly provided for viewing remotely.

### CROSS REFERENCE TO RELATED APPLICATIONS

This application claims priority under 35 U.S.C. §119(e) from provisional application no. 60/171,415, filed Dec. 21, 1999. The 60/171,415 provisional application is incorporated by reference herein, in its entirety, for all purposes.

### BACKGROUND OF THE INVENTION

1. Field of the Invention

The present invention relates generally to the field of communications traffic and traffic-sensitive resources including (but not limited to) trunks, lines, radio channels, etc. More particularly, the present invention relates to a method and apparatus for receiving, processing, and sending communications traffic information via a network to a visual display system.

2. Background Information

Telecommunications traffic is transmitted via channels known as lines or trunks. Since the amount of telecommunications traffic varies with time, and because telephone companies strive to make sure that there is sufficient channel capacity when traffic needs are at their highest, allocation of traffic to each trunk is made with the intention that there be plenty of capacity to handle peak demands. Algorithms allocating resources to handle traffic are merely predictive since there is no perfect a priori information on what demand will be for different types of telecommunications traffic flowing between different places.

Presently there are a number of different schemes available to help telecommunications service providers analyze their trunk utilization. Some systems store communications traffic information in a database and present it in table or graph form when requested by a user. These presentations are generic and not customized to specific users. Some systems configure a telephone switch to output communications traffic information in text-only reports. Typically, these systems are configured as databases that store traffic information and then permit a user to retrieve and manipulate that information. One example of such a system is Metrica NPR. Another example is Applied Digital Access' Traffic Data Collection and Engineering Operations System. These systems, and similar products, require that communications traffic data be stored in a database and then presented to a user only after the user requests data for a specific time period.

Current database-oriented products do not provide a metering function for communications system traffic-sensitive resource utilization because they store information in a database and then require a user to request information from the database for a specific time period.

Referring to FIG. 1, a conventional telecommunications traffic monitoring data handling database system is illustrated. Text or binary data indicative of trunk traffic is generated by a switch 101 and is provided to a processor 103. The processor 103 warehouses the data received from the switch 101 in a database 105. Upon receipt of specific commands from a user 107, the processor 103 retrieves select data from the database 105 for interpretation by the user 107.

Other conventional systems provide for real time displays of the number of traffic-sensitive resources currently in use at the present moment. These real time displays are based on transitory swings in telephony traffic, not necessarily reflective of the true, ongoing resource demand. Conventional real time systems are generally custom-designed systems created by individual communications system operators. Some real time systems produce graphical depictions of traffic information on a single display unit connected to a switching system either directly or via a collection device. In other words, these conventional systems do not make the graphical depictions available across a network.

Current real-time displays of the number of traffic-sensitive resources in use (as may be available directly on a switching system maintenance terminal) don't give a valid estimation of average utilization. That is because, by presenting real time data, they are subject to the bursty nature of communications traffic. False indications of average resource utilization can be obtained depending on whether a higher than average or lower than average traffic intensity is in effect at the time the display is observed. Furthermore, these display methods do not make use of accepted Erlang-B or Poisson formula based methods for estimating the traffic carrying capacity of a resource based on blocking probability and number of switches in the resource.

Systems that report traffic utilization in text-only format are less useful than graphic systems as they require more user interpretation in order to compare values between different resources than would be required if each resource's utilization were presented in a graphic format.

What is needed is a system that uses data sampled over a standard traffic reporting interval such as one hour, calculates utilization percentage based on resource size, desired blocking probability, and Erlang-B or Poisson formulas, and sends out the resulting utilization information in a form that will generate a graphic display of the estimated percentage utilization of the traffic sensitive resource(s), after each interval.

Furthermore, what is needed is a system that presents data tailored to a user's specific needs, unlike requesting information for a specific time period that will be extracted from the database on demand. What is needed is a meter system that is available upon a full sample of traffic information has been made and displayed in a manner readily usable by the requester.

Also, what is needed is a way for geographically diverse communications operating organizations to monitor resources in multiple locations without requiring human presence at each switching facility and without requiring links dedicated to the task of moving traffic data between each monitoring location and each communications switching facility being monitored.

Also what is needed is a way for technically diverse members (technicians, engineers, planners, operators, customer service personnel, etc.) of a communications operating organization to be able to focus attention first on the elements of the traffic data that are relevant to their respective primary responsibilities within the organization.

Also, what is needed is a way for geographically diverse communications operating organizations to be able to maintain historical maintenance and event tracking information in a log that is available at any location in the organization, and a way for a separate log of this type to exist for each traffic-sensitive resource.

Also, what is needed is a way for casual or occasional users of the information to be able to understand what each traffic-sensitive resource is used for or what it connects to without having to perform extra steps to look up this information. In other words, a method is needed for automatically showing a description of the traffic sensitive resource along with the resource utilization graphs.

Also, what is needed is a way to estimate the minimum number of switches needed to handle the traffic during the most recent sampling interval given a specified blocking probability, in order to provide maintenance personnel within a communications operating organization the ability to estimate how many switches may be removed from active service within a resource for maintenance purposes.

### SUMMARY OF THE INVENTION

It is an object of the present invention to provide near real time receiving, processing and sending of communications traffic information.

It is another object of the present invention to provide communications traffic information in a format that doesn't require a database.

It is yet another object of the present invention to provide traffic metering functionality, wherein a graphical display of utilization percentage of traffic sensitive resources is provided with automatic processing of traffic data and resending of display information when new traffic information is available from a communications system.

It is a further object of the present invention to provide an intermediate term linear forecast of trunk resource utilization based on historic utilization analysis.

It is yet another object of the present invention to provide dynamic alert messaging when trunk utilization exceeds a predefined threshold.

It is another object of the present invention to provide dynamic alert messaging when multiple trunk demand threshold events occur within a fixed time period.

It is yet another object of the present invention to provide at a listing of most utilized trunk groups across multiple switches for current time period and for peak time periods.

It is a further object of the present invention to provide at a listing at a web site of most utilized trunk groups across multiple switches for a current time period and for peak time periods.

It is an additional object of the present invention to provide near real time receiving, processing and sending of communications traffic information regarding a selected subset of trunks at a given switch.

It is still another object of the present invention to provide a capability to display estimated number of switches required and available for each resource.

It is a further object of the present invention to provide a network-oriented system whereby the sending of traffic information is over a network.

It is an additional object of the present invention to provide for a groupware function to promote communication and understanding of events and actions relating to each traffic-sensitive resource in a communications system.

It is another object of the present invention to provide a capability of sending to a multitude of devices, including but not limited to desktop devices and handheld devices.

It is an object of the present invention to provide a graphical display function that is accessible by all levels of employees within a communications operating organization.

It is another object of the present invention to provide an expanded description capability to indicate what type of traffic is carried by each traffic-sensitive resource.

It is yet another object of the present invention to provide a capability to have a database add-on in the event that historical data is desired.

It is still another object of the present invention to provide a capability to accommodate multiple input-data formats of the raw traffic data, to allow functionality with communications systems from multiple vendors.

It is a further object of the present invention to provide a capability to see when input data was not received for a particular time interval.

It is an additional object of the present invention to provide a capability to use encrypted and/or authenticated data transmission between the switching facility and the traffic monitoring server, and between the traffic monitoring server and the graphical display systems at any number of monitoring locations.

It is another object of the present invention to provide a capability to have multiple views of the traffic data, to suit the needs of different types of users of the traffic data. This may include (but is not limited to) a view sorted by capacity, a view sorted by mean holding time, and/or a view sorted by number of resource members required for a given blocking probability and traffic usage level above or below the present number of members available.

The present invention provides meter functionality for communications traffic and traffic sensitive resources. As traffic data from a standard measuring interval such as one hour is made available to the invention from a communications switching system, the invention receives the data, processes it, and creates the output necessary to send the information to a display device for graphical indication of communications resource utilization.

The data received from the voice switching system is processed according to the present invention, which means key data elements are extracted. The extracted data includes at a minimum, but is not limited to, the following pieces of data sampled over a standard time interval (typically one hour):

Traffic usage per resource

Seizure attempts per resource

Number of servers per resource

Out-of-service (OOS) usage per resource

OOS servers during the sample

The processing of communications system data is performed as soon as the data is available from the system. The output data representing a graphical display of the processed input data is made available as soon as processing has completed. As part of the graphical display information, numerical values may be included (associated with each resource) that represent performance parameters. These performance parameters include (but are not limited to) the number of out-of-service members, mean holding time, answer-seizure ratio, number of members required, number of members defined in the resource, and actual traffic usage level.

Some advantages of the present invention include:

Near-real-time output/meter functionality

Graphical output format of utilization

Self refreshing display

Capability of sending graphic output over a network

Database not required

Network distribution of graphical output information

Estimation of number of servers required for each resource

Indication of number of servers available for each resource

Smoothing of data so as not to over react to bursty activity

Analysis can be tailored to a subset of trunks, i.e., can be tailored to a single user

Automated notification of reaching of a simple threshold condition or of complex threshold conditions

Resource requirement projection based on historical utilization

“Hot spot” identification of trunk groups, e.g., top 20 peak demand groups

Sortability by capacity and performance parameters to focus attention on traffic-affecting problems by magnitude of the problem

On-line Log function for each resource which provides communication across time and across geography about maintenance or other events relating to each traffic-sensitive resource, which reduces time wasted by members of an organization

Encrypted and/or authenticated transmission of traffic data from the switching facility to the traffic monitoring server, and from the traffic monitoring server to the graphical display systems

Spreadsheet output format capability (e.g., comma-separated values) for exporting data to electronic spreadsheet programs

Capability to store usage levels over time in order to provide a graphical peak values display

Capability to store the time intervals for which traffic data has been received, in order to generate a graphic depiction of the times when traffic data was unavailable

Capability to display the raw traffic data along with the graphical traffic data in order to allow users to compare the two if needed

Capability to display a history of the traffic information per resource as a chart showing the pattern of resource utilization as well as any performance parameters, including but-not limited to overflow or answer/seizure ratio, over time.

Network-accessible help displays so that users do not have to maintain paper copies of instructions or reference materials at each location where the graphical traffic information is accessed

Capable of working with communications systems from multiple vendors

### BRIEF DESCRIPTION OF THE DRAWING

Additional objects and advantages of the present invention will be apparent in the following detailed description read in conjunction with the accompanying drawing figures.

FIG. 1 illustrates a conventional telecommunications traffic monitoring data handling database system.

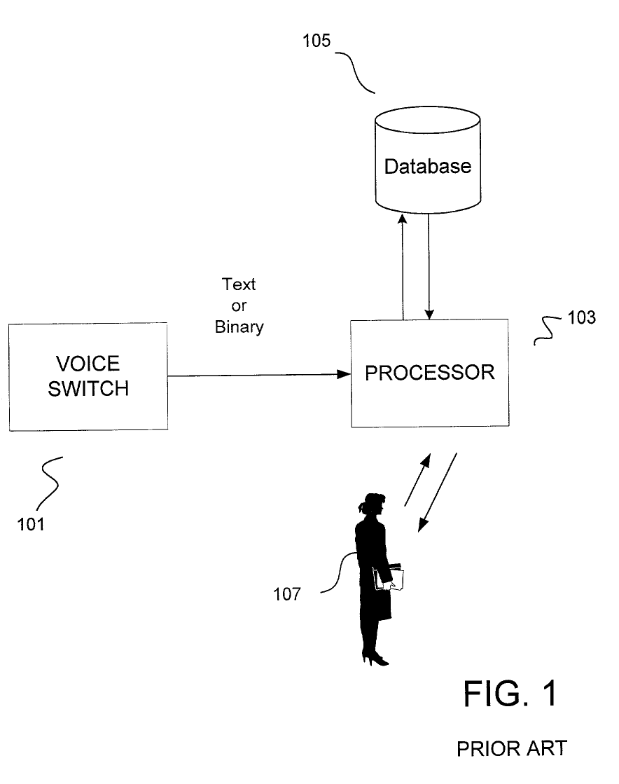

FIG. 2 illustrates how a network-based telecommunications traffic monitoring system, according to one embodiment of the present invention (and including an optional database), is integrated with a telecommunications switch.

FIG. 3 illustrates how a network-based telecommunications traffic monitoring system, according to another embodiment of the present invention, is integrated with plural telecommunications switches.

FIG. 4 illustrates how a network-based telecommunications traffic monitoring system, according to yet another embodiment of the present invention, is integrated with plural telecommunications switches.

FIG. 5 illustrates how a network-based telecommunications traffic monitoring system, according to still another embodiment of the present invention, is integrated with plural telecommunications switches.

FIG. 6 illustrates a network-based telecommunications traffic monitoring system, according to a preferred embodiment of the present invention, integrated with plural switches.

FIG. 7 illustrates how a network-based telecommunications traffic monitoring system, according to another embodiment of the present invention, is integrated with plural telecommunications switches.

FIG. 8 illustrates an example of a switch traffic status display page, according to an embodiment of the present invention.

FIG. 9 illustrates an example of a switch traffic display page, according to an embodiment of the present invention, wherein only basic statistics are displayed.

FIG. 10 illustrates an example of a switch traffic display page, according to an embodiment of the present invention, wherein full statistics are displayed.

FIG. 11 illustrates an example of a switch traffic display page, according to an embodiment of the present invention, wherein peak usage data are displayed.

FIG. 12 illustrates an example of a switch traffic display page, according to an embodiment of the present invention, wherein raw traffic data from a switch is displayed.

FIG. 13 illustrates an example of a switch traffic display page, according to an embodiment of the present invention, wherein availability of data from a switch is displayed.

FIG. 14 illustrates an example of a switch traffic display page, according to an embodiment of the present invention, wherein trunk data is sorted according to overflow status.

FIG. 15 illustrates an example of a switch traffic display page, according to an embodiment of the present invention, wherein trunk data is sorted according to the number of trunks in a trunk group that are out of service.

FIG. 16 illustrates an example of a switch traffic display page, according to an embodiment of the present invention, wherein trunk data is sorted according to mean hold time statistics for calls for each trunk group.

FIG. 17 illustrates an example of a switch traffic display page, according to an embodiment of the present invention, wherein trunk data is sorted according to the answer/seizure ratio statistics for each trunk group.

FIG. 18 illustrates an example of a switch traffic display page, according to an embodiment of the present invention, wherein trunk data is sorted for purposes of analyzing trunk group sizing based on sufficiently of traffic capacity.

### DETAILED DESCRIPTION OF THE INVENTION

This description uses the nomenclature “traffic monitoring,” which may also be understood by those of skill in the art as “traffic metering.” In other words, “monitoring” as referred herein is intended to have the meaning of “metering” as is understood in the art of telecommunications traffic analysis.

This invention accepts traffic and performance data from a communications system such as a voice switching system in a fixed or wireless telephone network, or such as a data switching system. Traffic usage data may be transferred on a scheduled basis from the communications system or it may be automatically requested from the communications system by the invention. This transfer may be done over a serial line or it may be via a network connection using a protocol such as FTP or HTTP.

The traffic data should represent measurements taken over a standard sampling interval such as one hour.

Once the traffic data is transferred, it is stored in a file within the traffic monitoring server. The server then refers to a map-file that contains information about the location within the traffic data file of the following key elements of information:

start and stop time of the traffic data report

usage during the interval (inbound, outbound, total, or a combination of these)

number of servers (e.g., trunks) in service during the sampling interval

call attempts, answered calls, overflow counts and/or percentages (or a combination of these), or none of these

out of service resources (e.g., trunks), or out of service usage of the resources

Using a system configuration file, the server determines what map-file should be used to extract the key information elements such as those mentioned above, and what unit conversion factor is necessary to convert the traffic usage measurements in the traffic data file into a common unit such as hundred call seconds per hour. Using the correct map-file and conversion factor, the server extracts the key data, converts it as needed, and stores the resulting data in an array variable.

The server looks at the number of resource members available, and looks into an Erlang-B or Poisson table to extract the amount of usage that can be carried by that number of members given a specified blocking probability. The server computes the ratio of usage to carriable usage for the given blocking probability to create a utilization percentage and stores this percentage in an array.

The server sorts the utilization values in the array and creates graphical information based on the sorted values. The graphical information may include but is not limited to Hypertext Markup Language (HTML), Handheld Device Markup Language (HDML), Wireless Markup Language (WML), and Extensible Markup Language (XML).

The server creates multiple views of the same data that may be accessed as needed by communications operator personnel in order to accomplish their primary tasks within the organization. The server also provides numerical information in its views to describe key performance factors that may be needed, including but not limited to members required, members available, mean holding time on a resource, answer/seizure ratio on a resource, reported traffic level on the resource, and incoming and outgoing seizures of the resource.

For communications operator personnel who need to extract the same data to an electronic spreadsheet program, the server may create comma-separated-value representations of the data for direct export to a spreadsheet program capable of importing comma-separated data.

These graphical views of data are provided on a near real time basis. Providing graphical representations of estimated resource utilization calculations on a near real time basis for review by the subscriber is very useful because it avoids the problem of not being able to make useful sense of a true real time utilization display due the bursty nature of such data streams. The near real time display is also advantageous over the conventional database formats that do not provide data on a timely basis and that place a substantial search and processing burden on the subscriber seeking to view the data. Providing a display that is based on statistical analysis of an appropriate time sample and that is then promptly provided for viewing fits the meaning (for purposes of this disclosure) of “near real time.”

The server may keep a history of when raw traffic data was received from a communications switching system, so that a graphical depiction of data availability can be created. This graphical depiction can be used to obtain a fast indication of how often raw traffic data was unavailable to the server for processing.

The server may also keep a history of the traffic information per resource so that a chart can be created as needed showing the pattern of resource utilization over time. One optional aspect of the present invention is to use an intermediate term of data (e.g., 21 days) to predict utilization requirements over some next interim period of time (e.g., 6 weeks).

The server is optionally programmed to deliver alerts when certain utilization thresholds are reached. According to one aspect of this functionality, alerts are based upon a simple criterion such as a factor of calls blocked or exceeding any other absolute threshold of interest. It is also an aspect of the present invention that an alert optionally be based on more complex criteria such as achieving a predetermined number of saturation conditions over a predetermined span of hours.

The server may also make the raw traffic data available along with the graphical depiction of the data, in order to allow users to verify the accuracy of the server's calculations if necessary.

The server may also keep a history per resource of traffic levels over time so that peak traffic levels can be obtained and displayed along with the date and time of the peaks.

One embodiment of the present invention provides a list of the most utilized resources such as trunk groups across multiple switches during peak periods as well as current periods. This so called “hot spots” list may be published at a web site or other display locations. The hot spots list is preferably updated dynamically.

The server provides the graphical traffic data information in such a way that display devices on a connected network can access the data. The access may be done using encryption and/or authentication in order to protect the security of the graphical information as it moves from the server to the display system.

Access to the traffic data can be via wired connectivity, wireless connectivity, or a combination of both.

In a preferred embodiment, the communications switching system will send raw traffic data to a computer in the communications operator's network that will store the traffic data in files. A scheduled job on this computer will automatically send the files over a TCP/IP network to a statistics relay unit (a function of the invention being claimed) which will transfer the file using encryption to the traffic monitoring server located at a distant location, either within the communications operator's network, or outside the network. The traffic monitoring server will process the file and generate HTML pages representing the different views that may be desired, and make these files available across a network via an HTTP server.

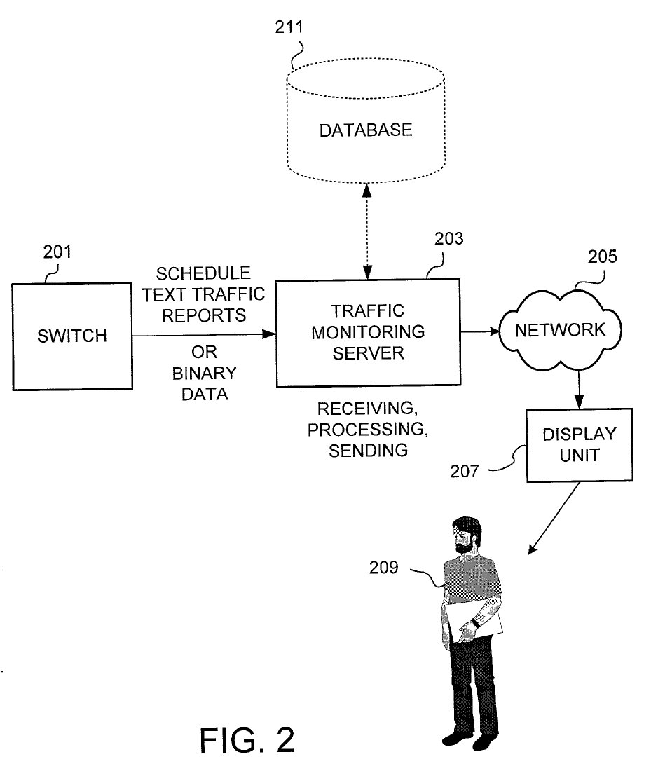

Referring to FIG. 2, integration of a telecommunications switch with a network-based telecommunications traffic monitoring system, according to one embodiment of the present invention, is illustrated. A telecommunications switch 201 provides traffic data, either in the form of binary data or text traffic reports, to a traffic monitoring server 203. In addition to receiving the traffic data from the switch 201, the server 203 processes the data into a form suitable for cogent presentation and sends the processed data on for remote display. The processed data is sent by the server 203 to a display unit 207 via a network 205. A user 209 views the processed traffic data as displayed on the display unit 207.

Optionally, the traffic monitoring system includes a database 211. The database 211 is provided in the event that the user 209 wishes to review old records for historical analysis or other purposes.

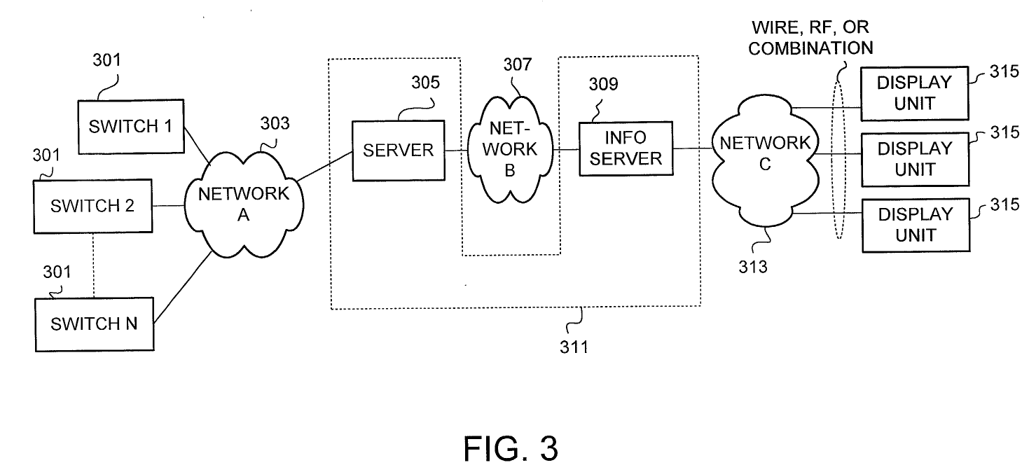

Referring to FIG. 3, integration of plural telecommunications switches with a network-based telecommunications traffic monitoring system, according to another embodiment of the present invention, is illustrated. Plural telecommunication switches 301 send traffic data via a network A 303 to a statistics relay unit (SRU) 305. The SRU 305 gathers the diverse traffic data from the switches 301 and sends it to an information condensing server 309, via a network B 307, for processing and transmission to display units 315. Transmission between the information condensing server 309 and the display units 315 is handled via a network C 313. The links between the display units 315 and the network C 313 may be via wire, wireless (e.g., RF, infrared), or a combination thereof.

Although the SRU 305 and the information condensing server 309 are portrayed as being remote from one another (communicating via a network B 307), they may be considered to be functioning as a unified server system 311 that collectively receives, processes, and sends traffic information. The processing burden may be handled by either the SRU 305 or the information server 309, or shared between the two.

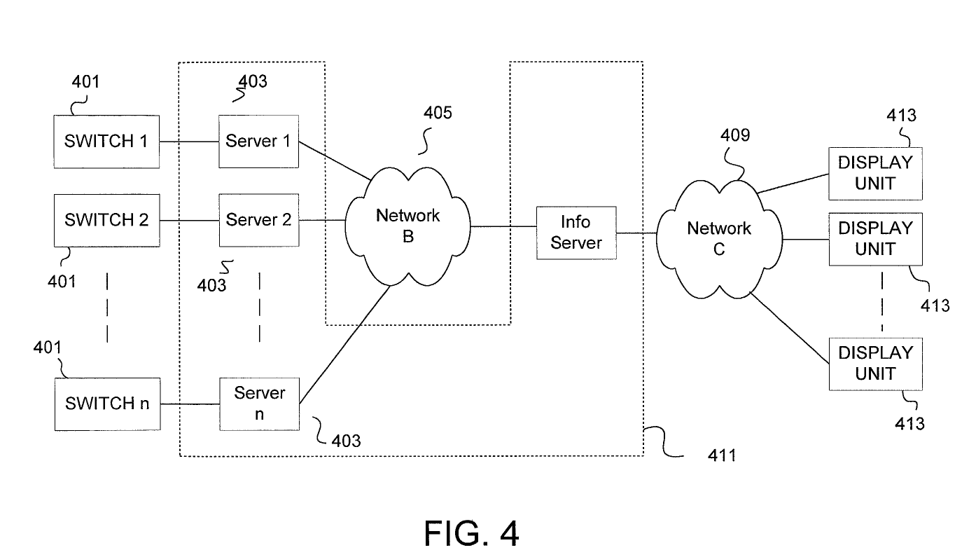

Referring to FIG. 4, integration of plural telecommunications switches with a network-based telecommunications traffic monitoring system, according to yet another embodiment of the present invention, is illustrated. Each of a plurality of telecommunications switches 401 is connected to a respective SRU 403. The SRUs 403 each receive traffic data from a switch 401 and transmit it on to an information condensing server 407, via a network B 405, for processing and transmission to display units 413. Transmission between the information condensing server 407 and the display units 413 is handled via a network C 409.

Although the SRUs 403 and the information condensing server 407 are portrayed as being remote from one another (communicating via a network B 405), they may be considered to be functioning as a unified server system 411 that collectively receives, processes, and sends traffic information. The processing burden may be handled by either the SRUs 403 or the information condensing server 407, or shared between the two.

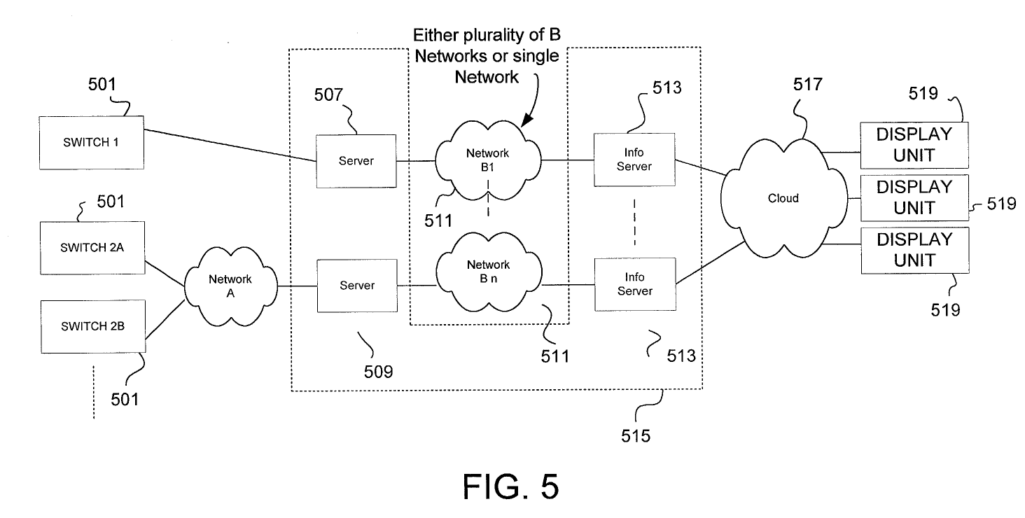

Referring to FIG. 5, integration of plural telecommunications switches with a network-based telecommunications traffic monitoring system, according to still another embodiment of the present invention, is illustrated. A first telecommunications switch 501 is connected to provide traffic data to a first SRU 507. Additional telecommunication switches 503 provide traffic data to an additional SRU 509 via a network 505. The plural SRUs 507, 509 provide the traffic data gathered from diverse sources to plural information condensing servers 513. The data is transmitted form the SRUs 507, 509 to the information condensing servers 513 via one or more networks 511. Plural networks B1 through Bn are illustrated, however these may alternatively be implemented as a single network rather than plural. The information condensing servers 513 process the traffic data and transmit it to display units 519. Transmission between the information condensing servers 513 and the display units 519 is handled via a network 517.

Although the SRUs 507, 509 and the information condensing servers 513 are portrayed as being remote from one another (communicating via networks 511), they may be considered to be functioning as a unified server system 515 that collectively receives, processes, and sends traffic information. The processing burden may be handled by either the SRUs 507, 509 or the information condensing servers 513, or shared between them.

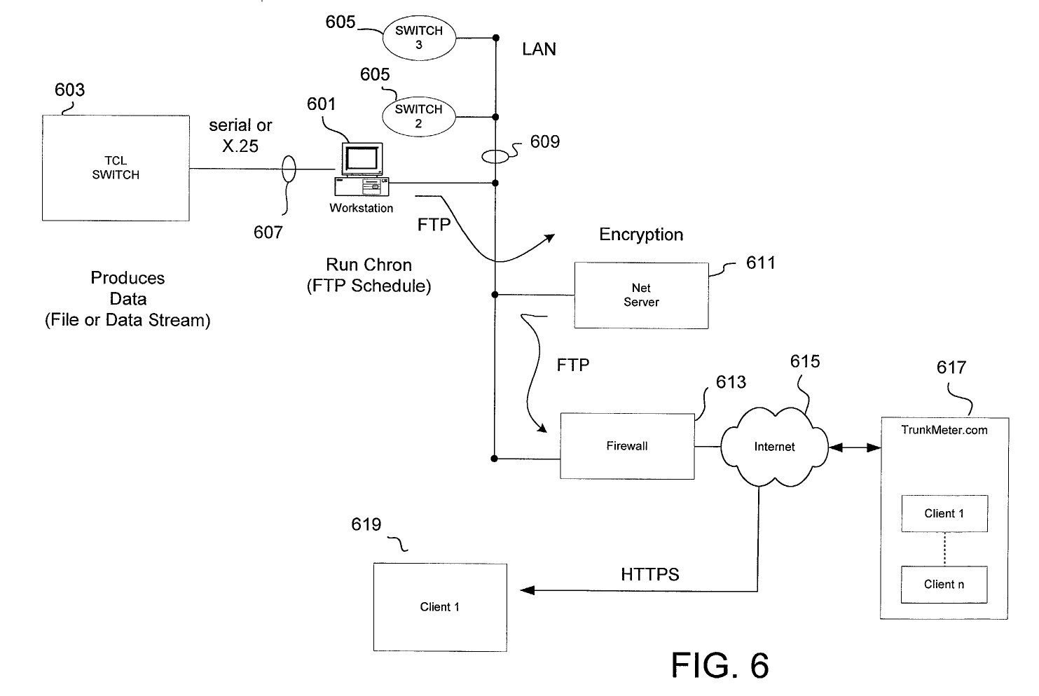

Referring to FIG. 6, integration of plural switches with a network-based telecommunications traffic monitoring system, according to a preferred embodiment of the present invention, is illustrated. A workstation 601 gathers traffic data from a telephone switch 603 via a data link 607. The data link 607 may be a serial (e.g., RS-232) or x.25 connection. This data may be in the form of discrete files or data streams. The data gathered by the workstation 601 is periodically transferred according to file transfer protocol (FTP) to a network SRU 611. The SRU 611 also gathers traffic data from additional switches 605 via a local area network (LAN) 609. The network SRU 611 encrypts the traffic data and sends the encrypted data via FTP to a firewall 613 that interfaces with the Internet 615. The use of encryption provides for a secure link when transmitting the data over the Internet 615.

The traffic data is transferred via the Internet from the firewall 613 to a data condensing server 617 that hosts a traffic monitoring web site (e.g., “trafficmonitoring.com” or “trunkmeter.com”). The web site at server 617 permits multiple clients to access traffic data according to their respective permissioning rights. A particular client 619 accesses the server 617 to retrieve that client's respective information by performing a hypertext transfer protocol (HTTP) transaction via the Internet 615.

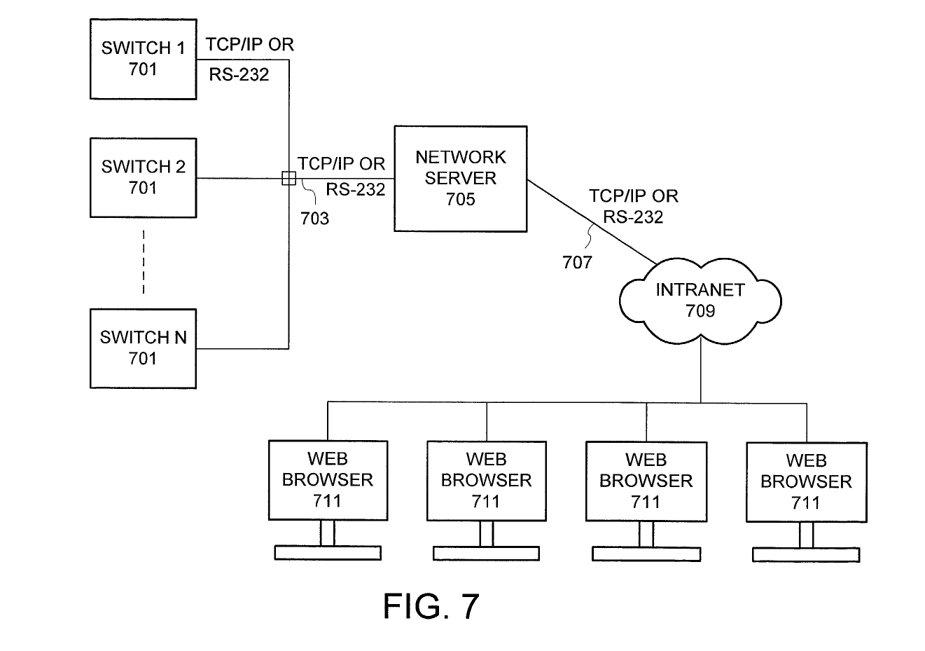

Referring to FIG. 7, integration of plural telecommunications switches with a network-based telecommunications traffic monitoring system, according to another embodiment of the present invention, is illustrated. Plural telecommunication switches 701 send traffic data to a co-located monitor server 705 using a convenient local transmission scheme 703 (e.g., TCP/IP or serial RS-232). This server 705 combines the functional aspects, as depicted in other embodiments, of a statistics relay unit (SRU) for gathering the diverse traffic data from the switches 701 with an information condensing processor. This analysis is transmitted, using a TCP/IP link 707, via an intranet network 709, to network surveillance display units 711. The display units are depicted as using a web browser to display the information. Additionally, they may use other multimedia forms of delivery including audible signaling.

While the link between the switches 701 and the monitor server 705 have been described as a serial cable or TCP/IP cable link, the transmission between the switches 701 and the monitor server 705 may be wireless (e.g., RF or infrared) or some combination of wire and wireless. Further, the linkage 703 may be part of the same intranet network 709 used to transmit the processed information. The links between the display units 711 and the intranet network 709 may also be via wire, wireless (e.g., RF or infrared), or a combination thereof. Of course the network 709 need not be limited to an intranetwork implementation, and is optionally embodied as an open network, including for example, a global communications network of interconnected networks.

Comparing the embodiment of FIG. 7 with that illustrated in FIG. 3, it is seen that although the SRU 305 and the information condensing server 309 are portrayed as being remote from one another (communicating via a Network B 707), they may be considered (conceptually, at least) to be functioning as a unified server system 311 that collectively receives, processes, and sends traffic information. The processing burden may be handled by either the SRU 305 or the information server 309, or shared between the two. The embodiment of FIG. 7 takes this conceptualization one step further and actually condenses the functionalities of the two separate servers of the FIG. 3 embodiment into only a single server (or, equivalently, plural co-located servers operating so as to emulate a single server).

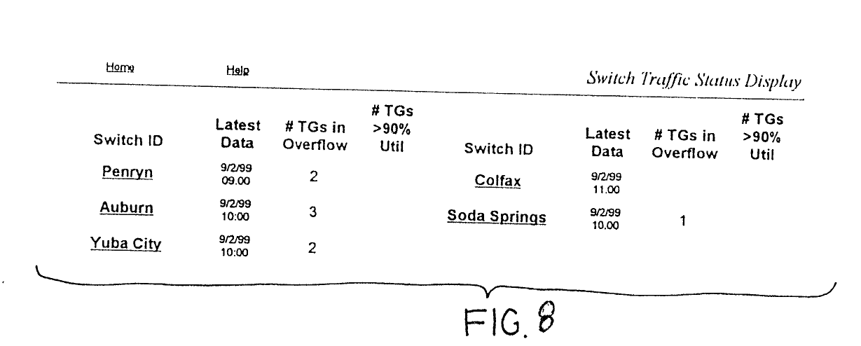

Referring to FIG. 8, an example of a switch traffic status display page is illustrated. The switch traffic status display is relatively high level and it indicates that data from five separate switches (according to this example) is available for viewing. It also provides abbreviated information about each of the five switches, such as how current the latest data is, the number of trunk groups (TGs) in overflow state and the number of TGs that are over 90% utilized.

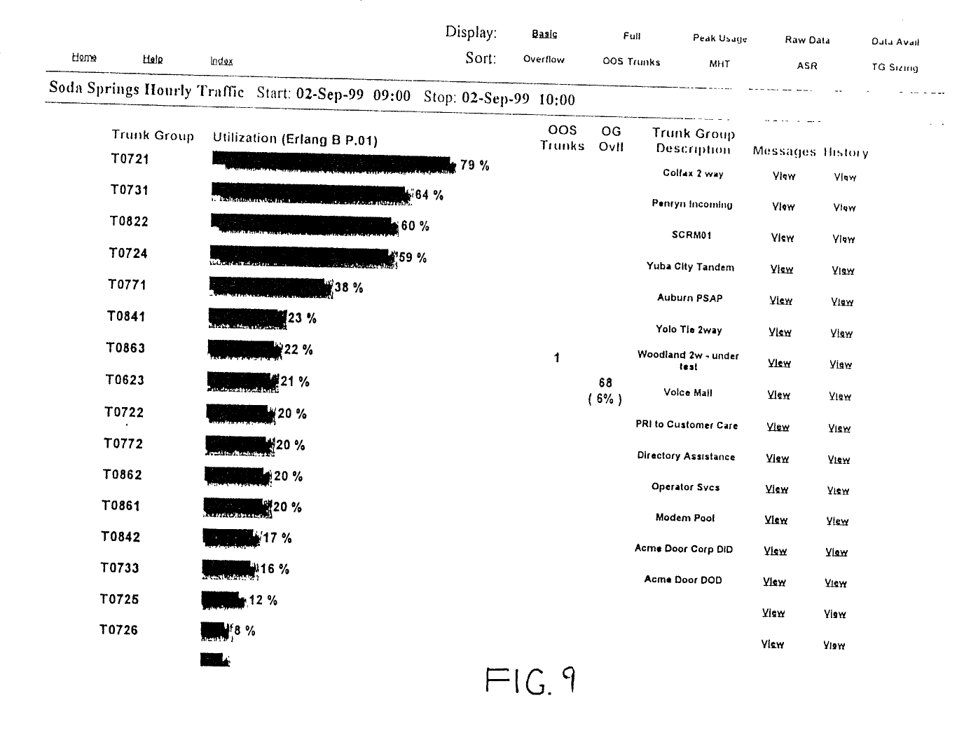

Referring to FIG. 9, an example is shown of a switch traffic display page, according to an embodiment of the present invention, wherein only basic statistics are displayed. Statistics are displayed for each trunk group regarding utilization, out of service trunks, and overflow status. A textual description is also shown for each trunk group.

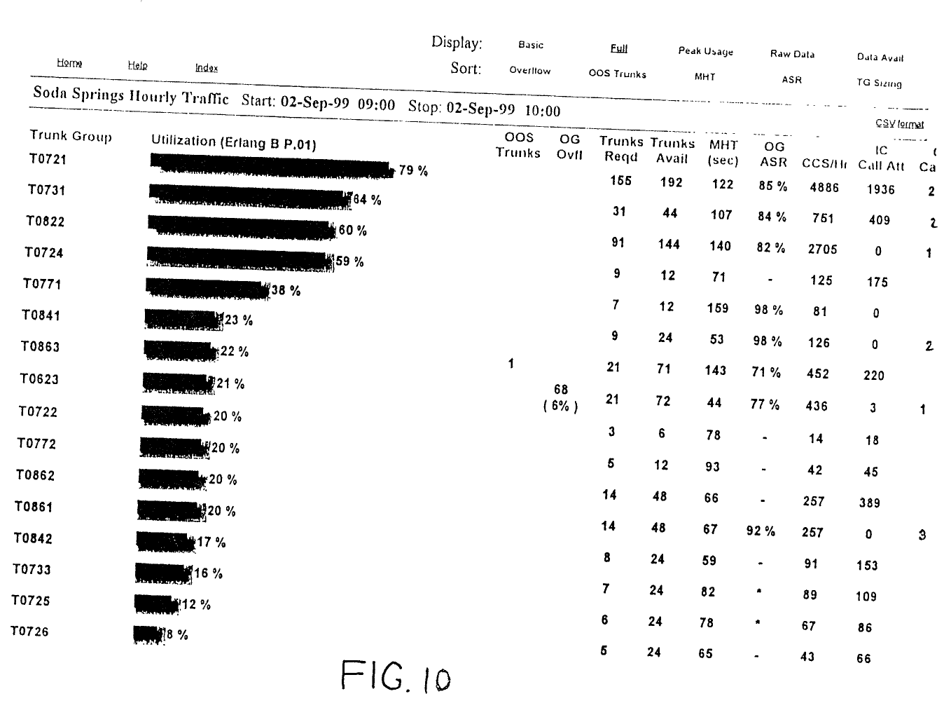

Referring to FIG. 10, an example is shown of a switch traffic display page, according to an embodiment of the present invention, wherein full statistics are displayed. In addition to out of service and overflow statistics, numerical information is also shown for number of trunks required, number of trunks available, mean hold time, answer/seizure ratio, etc.

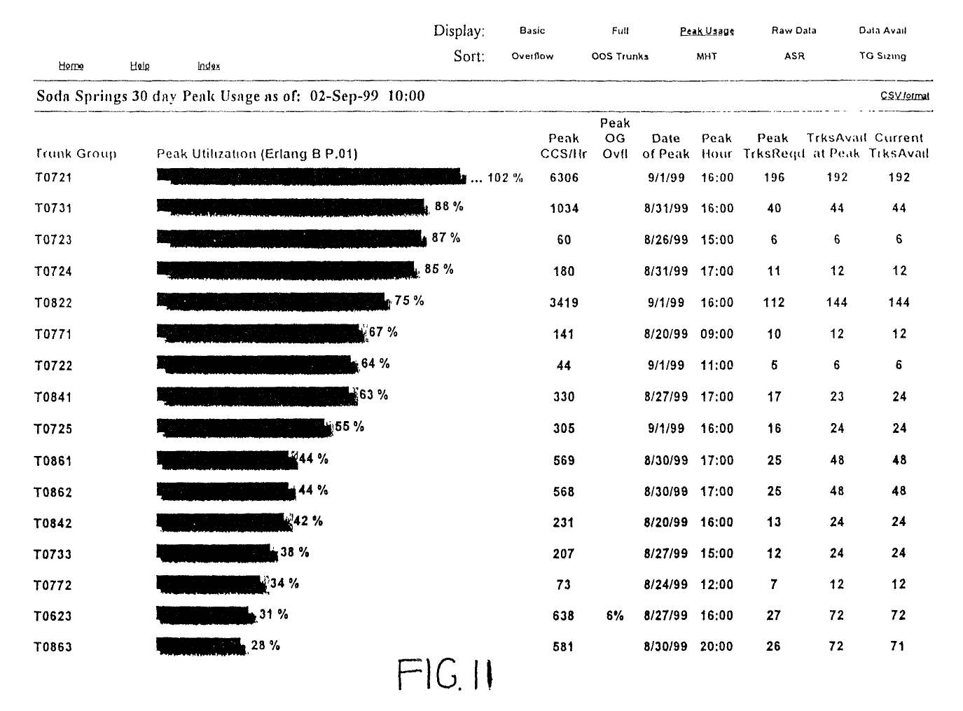

Referring to FIG. 11, an example is shown of a switch traffic display page, according to an embodiment of the present invention, wherein peak usage data are displayed. The trunk groups are displayed in descending order according to their utilization at their respective peak times.

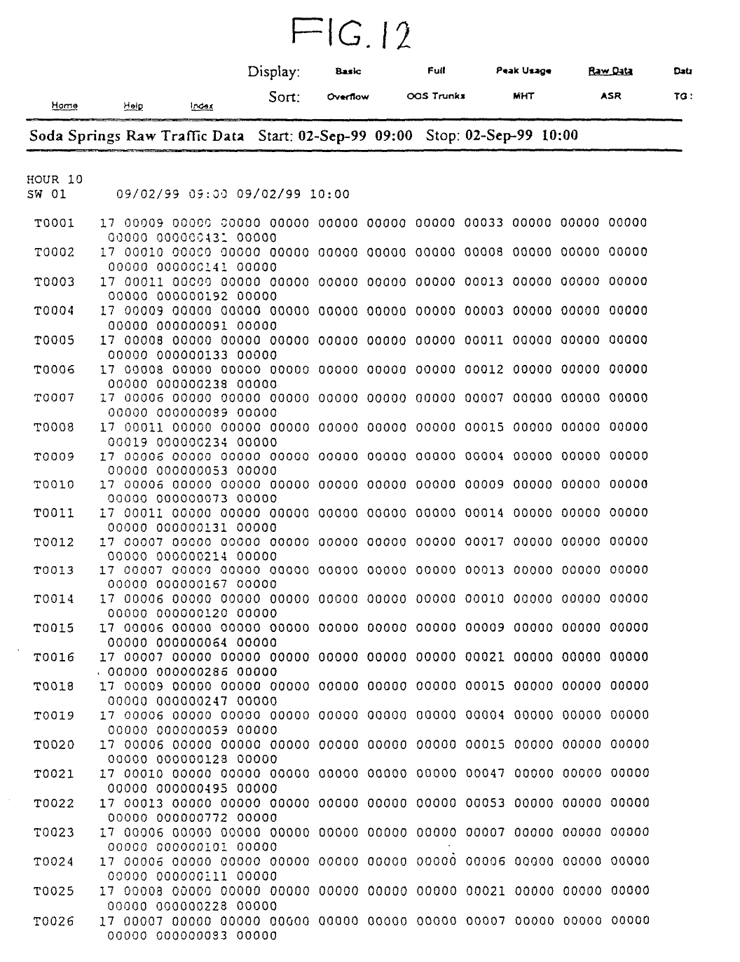

Referring to FIG. 12, an example is shown of a switch traffic display page, according to an embodiment of the present invention, wherein raw traffic data from a switch is displayed.

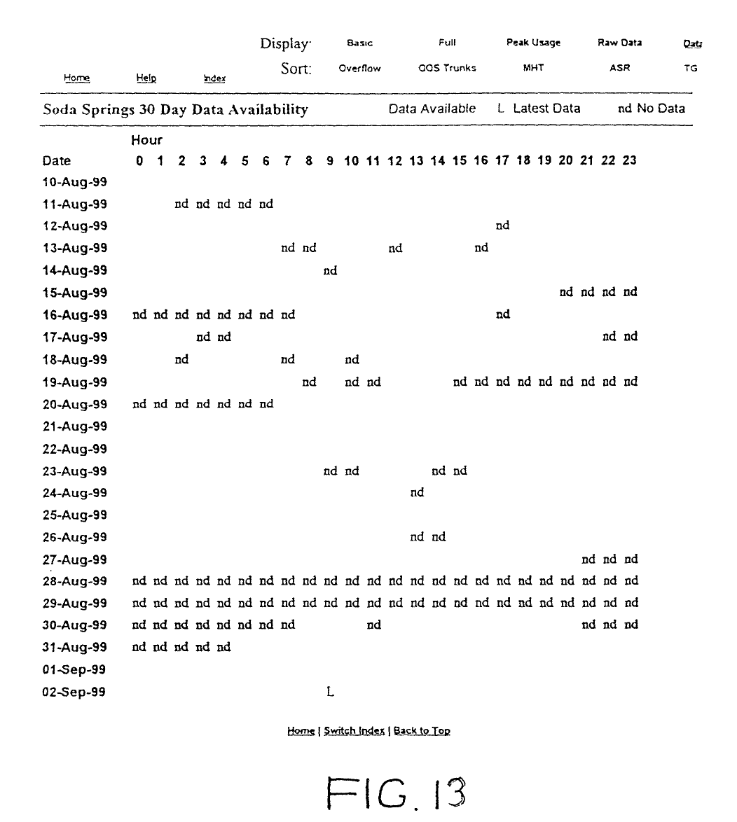

Referring to FIG. 13, an example is shown of a switch traffic display page, according to an embodiment of the present invention, wherein availability of data from a switch is displayed. The “nd” notations indicate hours in a given day for which no data was available from the switch. This view is useful for helping the user evaluate at a glance how reliable the statistics are for a given time period.

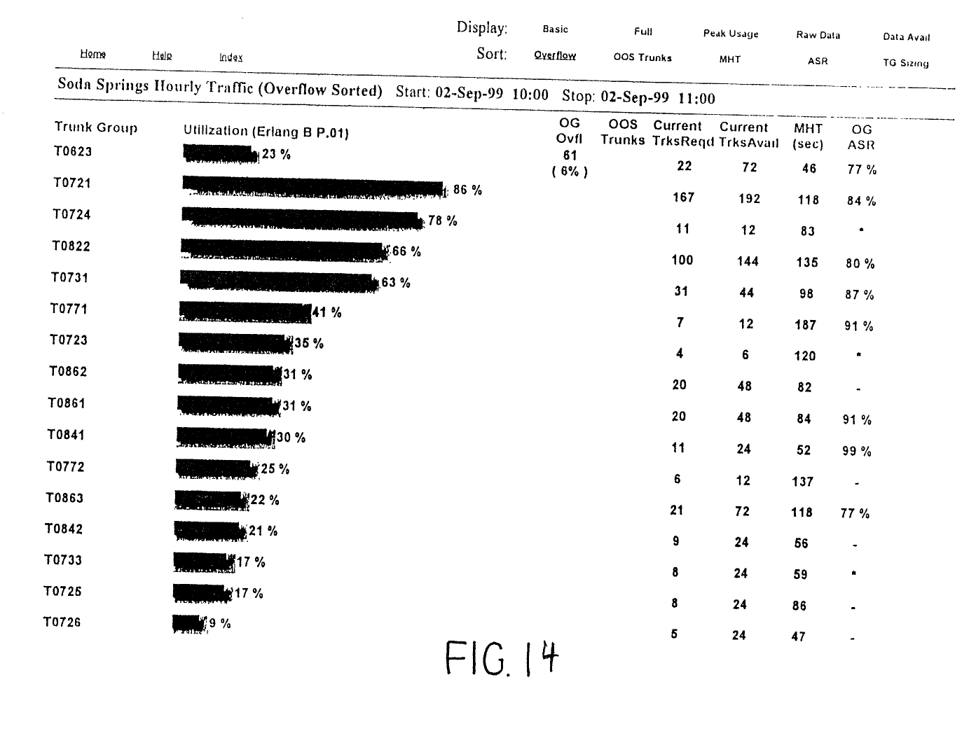

Referring to FIG. 14, an example is shown of a switch traffic display page, according to an embodiment of the present invention, wherein trunk data is sorted according to overflow status. This view is useful for quickly spotting overflow priorities.

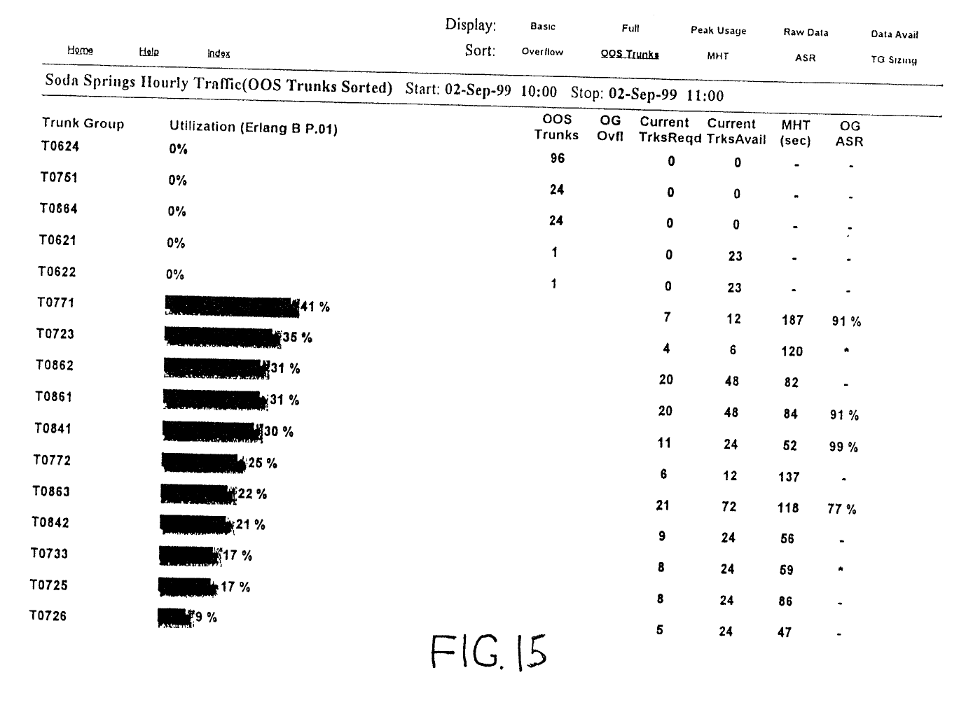

Referring to FIG. 15, an example is shown of a switch traffic display page, according to an embodiment of the present invention, wherein trunk data is sorted according to the number of trunks in a trunk group that are out of service. This view is useful for quickly spotting trunk groups that have the largest numbers of out of service trunks.

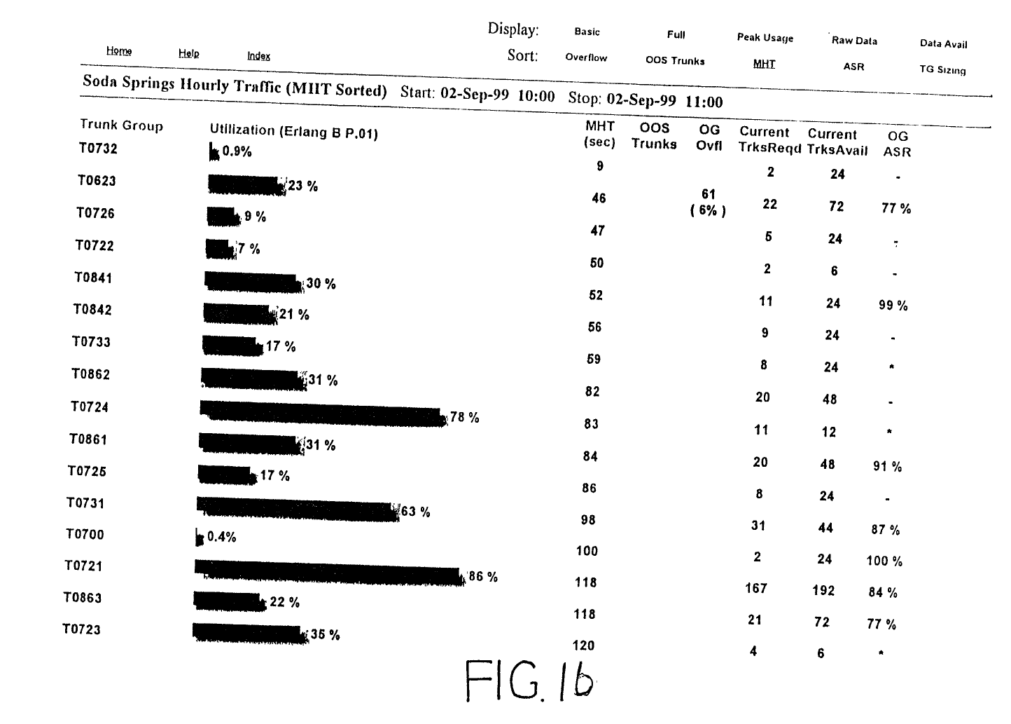

Referring to FIG. 16, an example is shown of a switch traffic display page, according to an embodiment of the present invention, wherein trunk data is sorted according to mean hold time statistics for calls for each trunk group. The mean hold time for each trunk group helps a network engineer assess how much extra capacity may be appropriate for avoiding under capacity situations at peak usage.

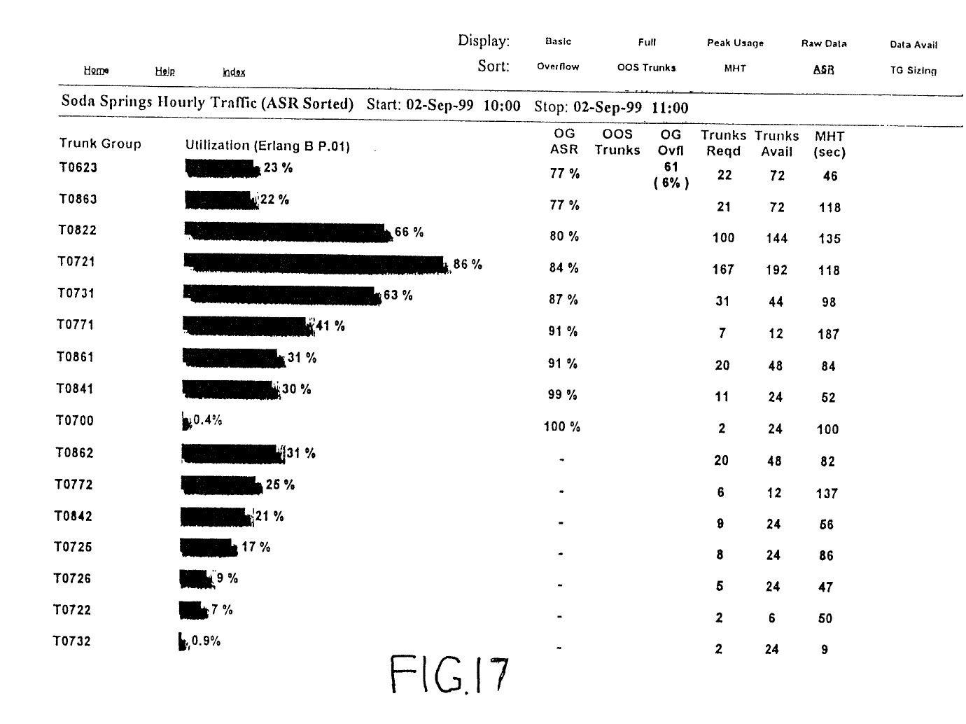

Referring to FIG. 17, an example is shown of a switch traffic display page, according to an embodiment of the present invention, wherein trunk data is sorted according to the answer/seizure ratio (ASR) statistics for each trunk group. This is an indication of how much of the traffic can be billed to customers.

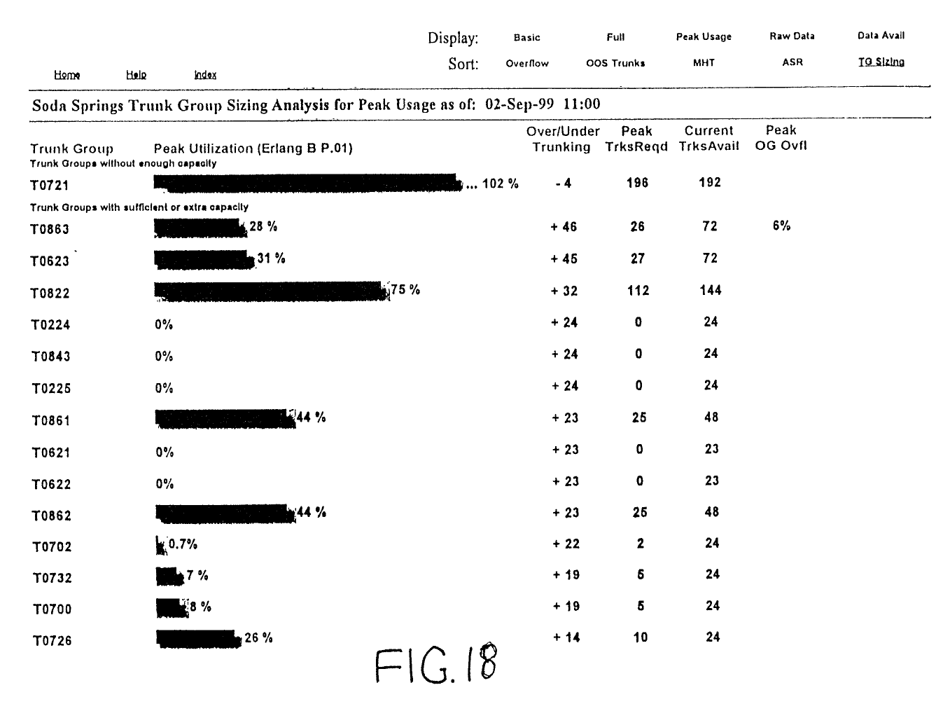

Referring to FIG. 18, an example is shown of a switch traffic display page, according to an embodiment of the present invention, wherein trunk data is sorted for purposes of analyzing trunk group sizing based on sufficiency of traffic capacity. At the top of the view is a single trunk group that is characterized as being “without enough capacity.” The remaining trunk groups are labeled as having “sufficient or extra capacity.” Each trunk group is assigned an Over/Under Trunking value and is ranked accordingly in the view.

The present invention facilitates traffic engineering by providing display of thirty-day peak traffic values with the number of trunks required to handle peak traffic. In a more time sensitive context, the present invention's near real time traffic graphs let translations engineers and managers see the effects of routing and translations changes as soon as possible.

Network operations personnel can see at a glance, both before and during maintenance activities, how many trunks need to be kept in service to accommodate customer traffic. For purposes of network optimization, the trunk group sizing display (refer to FIG. 18) shows which routes are most over-trunked or under-trunked.

According to an alternate embodiment, identification of an under-trunk (or over-trunk) situation is handled in an automatic fashion. Predetermined resource utilization thresholds (either simple or complex) are used to make an automatic decision for re-allocating trunks to better accommodate customer traffic. For example, a business that leases a nominal number of lines from a local communications service provider can purchase additional lines for its use via an automated, threshold-based algorithm, according to a pre-arranged agreement. This permits dynamic management of resource utilization so as to prevent a traffic handling crisis without the need for constant monitoring by a skilled operator.

In an over-trunk situation, an automated algorithm according to this embodiment provides for incremental portions of the business's lines to be removed from service (preferably, as provided for by a pre-arranged agreement), so that those lines are free to be used by other entities.

Resource re-allocation according to either the under-trunk or over-trunk situations is done automatically, with a contemporaneous notification to the affected parties: operating personnel monitoring the operations of the switch, as well as the relevant managers of the customers affected by the changes.

An alternate embodiment of the invention is that the server is adapted to analyze traffic data for a subset of trunks or trunk groups that are utilized by an individual subscriber. That subscriber is provided with access only to the data that corresponds to the subset of trunks or trunk groups that subscriber utilizes. This allows for information delivery to be pinpointed to the specific user (or users) for whom the subset monitoring is appropriate.

Placing the data to be displayed on a server that can be accessed via the Internet puts the data in the hands of any authorized person (i.e., in possession of current passwords, etc.) to review all the above-discussed information online via any computer implementing a standard web browser.

The present invention has been described in terms of preferred embodiments, however, it will be appreciated that various modifications and improvements may be made to the described embodiments without departing from the scope of the invention.

What is claimed is:

1. A method for monitoring and reporting of communications line traffic information, the method comprising:
receiving real time line traffic resource utilization data from a switch;
estimating resource utilization at the switch, based on the line traffic resource utilization data that has been collected over a sample period of predetermined length, using a statistical estimation method so as to discount bursty utilization activity, thereby producing an estimated resource utilization calculation; and
publishing the estimated resource utilization calculation to an electronic publishing resource from which the published estimated resource utilization calculation is accessible by a subscriber.

2. The method for monitoring and reporting of communications line traffic information of claim 1, further comprising:
alerting the subscriber in the event that the estimated resource utilization calculation surpasses a predetermined threshold resource utilization condition.

3. The method for monitoring and reporting of communications line traffic information of claim 2, further comprising:
alerting the subscriber in the event that the estimated resource utilization calculation surpasses a predetermined number of threshold resource utilization conditions within a predetermined time period.

4. The method for monitoring and reporting of communications line traffic information of claim 2, wherein the alerting comprises an e-mail message.

5. The method for monitoring and reporting of communications line traffic information of claim 2, wherein the alerting comprises an audible alarm.

6. The method for monitoring and reporting of communications line traffic information of claim 2, wherein the alerting comprises posting an alert at a web site.

7. The method for monitoring and reporting of communications line traffic information of claim 1, wherein the sample period of predetermined length is within a range of about 20 minutes to about 90 minutes.

8. The method for monitoring and reporting of communications line traffic information of claim 7, wherein the sample period of predetermined length is about one hour.

9. The method for monitoring and reporting of communications line traffic information of claim 1, wherein the estimating is performed using an Erlang-B distribution formula.

10. The method for monitoring and reporting of communications line traffic information of claim 1, wherein the estimating is performed using a Poisson distribution formula.

11. The method for monitoring and reporting of communications line traffic information of claim 1, further comprising:
repeating the estimating and the publishing on a regular basis.

12. The method for monitoring and reporting of communications line traffic information of claim 11, further comprising:
compiling the repeated estimated resource utilization calculations into a database over a predetermined compiling time period.

13. The method for monitoring and reporting of communications line traffic information of claim 1, further comprising:
repeating the estimating and the publishing so as to provide estimated resource utilization calculations on a near real time basis for review by the subscriber.

14. The method for monitoring and reporting of communications line traffic information of claim 1, wherein the estimated resource utilization calculation is published so as to provide for ease of comprehension by technically diverse subscribers.

15. A method for monitoring and reporting of communications line traffic information, the method comprising:
receiving real time line traffic resource utilization data for a line set, said line set comprising one or more communications lines corresponding to a single subscriber;
estimating resource utilization for the line set, based on the line traffic resource utilization data that has been collected over a sample period of predetermined length, using a statistical estimation method so as to discount bursty utilization activity, thereby producing an estimated resource utilization calculation; and
publishing the estimated resource utilization calculation to an electronic publishing resource from which the published estimated resource utilization calculation is accessible by a subscriber.

16. The method for monitoring and reporting of communications line traffic information of claim 15, further comprising:
alerting the subscriber in the event that the estimated resource utilization calculation surpasses a predetermined threshold resource utilization condition.

17. The method for monitoring and reporting of communications line traffic information of claim 16, further comprising:
alerting the subscriber in the event that the estimated resource utilization calculation surpasses a predetermined combination of threshold resource utilization conditions within a predetermined time period.

18. The method for monitoring and reporting of communications line traffic information of claim 16, wherein the alerting comprises an e-mail message.

19. The method for monitoring and reporting of communications line traffic information of claim 16, wherein the alerting comprises an audible alarm.

20. The method for monitoring and reporting of communications line traffic information of claim 16, wherein the alerting comprises posting an alert at a web site.

21. The method for monitoring and reporting of communications line traffic information of claim 15, wherein the sample period of predetermined length is within a range of about 20 minutes to about 90 minutes.

22. The method for monitoring and reporting of communications line traffic information of claim 12, wherein the sample period of predetermined length is about one hour.

23. The method for monitoring and reporting of communications line traffic information of claim 15, wherein the estimating is performed using an Erlang-B distribution formula.

24. The method for monitoring and reporting of communications line traffic information of claim 15, wherein the estimating is performed using a Poisson distribution formula.

25. A traffic monitoring server system in electrical communication with one or more telecommunication switches and an open network, the system comprising:
one or more statistics relay servers receiving real time line traffic resource utilization data from the one or more switches, wherein the statistics relay servers process the received data, based on the line traffic resource utilization data that has been collected over a sample period of predetermined length, using a statistical estimation method so as to discount bursty utilization activity, to produce estimated resource utilization calculations for each of the switches; and
one or more information condensing servers receiving the estimated resource utilization calculations from the statistics relay servers via an intermediate network connection;
wherein the information condensing servers send graphical reports via the open network for review by a subscriber based on the estimated resource utilization calculations received from the statistics relay servers.

26. A traffic monitoring server system in electrical communication with a telecommunication switch and an open network, the system comprising:
one or more statistics relay servers receiving real time line traffic resource utilization data from one or more switches; and
one or more information condensing servers receiving the line traffic resource utilization data from the statistics relay servers, as relayed via an intermediate network connection, wherein the information condensing servers process the received data, based on the line traffic resource utilization data that has been collected over a sample period of predetermined length, using a statistical estimation method so as to discount bursty utilization activity, to produce estimated resource utilization calculations for each of the switches;
wherein the information condensing servers send graphical reports via the open network for review by a subscriber, based on the estimated resource utilization calculations.

27. A traffic monitoring server system in electrical communication with a telecommunication switch and an open network, the system comprising:
a statistics relay server receiving real time line traffic resource utilization data from the switch, wherein the statistics relay server process the received data, based on the line traffic resource utilization data that has been collected over a sample period of predetermined length, using a statistical estimation method so as to discount bursty utilization activity, to produce estimated resource utilization calculations for the switch; and
an information condensing server receiving the estimated resource utilization calculations from the statistics relay server via an intermediate network connection;
wherein the information condensing server sends a graphical report via the open network for review by a subscriber based on the estimated resource utilization calculations received from the statistics relay server.

28. A traffic monitoring server system in electrical communication with a telecommunication switch and an open network, the system comprising:
a statistics relay server receiving real time line traffic resource utilization data from the switch; and
an information condensing server receiving the line traffic resource utilization data from the statistics relay server, as relayed via an intermediate network connection, wherein the information condensing server process the received data, based on the line traffic resource utilization data that has been collected over a sample period of predetermined length, using a statistical estimation method so as to discount bursty utilization activity, to produce estimated resource utilization calculations for the switch;
wherein the information condensing server sends a graphical report via the open network for review by a subscriber, based on the estimated resource utilization calculations.

29. The traffic monitoring server system of claim 28, wherein a database is provided at the information condensing server that permits logging by authorized personnel of traffic utilization issues.

30. The traffic monitoring server system of claim 28, wherein the information condensing server is located remotely from the switch.

31. The traffic monitoring server system of claim 28, wherein the subscriber is free to view the graphical report at a location that is remote from the information condensing server.

32. A traffic monitoring server system in electrical communication with a telecommunication switch and an open network, the system comprising:
a statistics relay server receiving real time line traffic resource utilization data from the switch; and
an information condensing server receiving the line traffic resource utilization data from the statistics relay server, as relayed via an intermediate network connection;
wherein line traffic resource utilization data that has been collected over a sample period of predetermined length is processed, using a statistical estimation method so as to discount bursty utilization activity, to produce estimated resource utilization calculations for the switch; and
wherein the information condensing server sends a graphical report via the open network for review by a subscriber, based on the estimated resource utilization calculations.

33. The traffic monitoring server system of claim 32, wherein the processing of line traffic resource utilization data is implemented via the statistics relay server.

34. The traffic monitoring server system of claim 32, wherein the processing of line traffic resource utilization data is implemented via the information condensing server.

35. The traffic monitoring server system of claim 32, wherein the processing of line traffic resource utilization data is implemented via both the statistics relay server and the information condensing server.

36. A method for monitoring and reporting of communications line traffic information, the method comprising:
receiving line traffic resource utilization data from a switch;
collecting the received line traffic resource utilization data over a time period of predetermined length;
estimating resource utilization at the switch, based on the collected line resource utilization data, using a statistical estimation method so as to discount bursty utilization activity, thereby producing an estimated resource utilization calculation;
publishing the estimated resource utilization calculation to an electronic publishing resource from which the published estimated resource utilization calculation is accessible by a subscriber; and
repeating the receiving, the collecting, the estimating, and the publishing on a regular basis.

37. The method for monitoring and reporting of communications line traffic information of claim 36, the method further comprising:
compiling the repeated estimated resource utilization calculations over a predetermined compiling time period;
predicting resource utilization for a predetermined prediction time period; and
publishing the resource utilization prediction to an electronic publishing resource from which the published resource utilization is accessible by the subscriber.

38. The method for monitoring and reporting of communications line traffic information of claim 37, wherein the predetermined prediction time period is about six weeks and wherein the predetermined compiling time period is about three weeks.

39. The method for monitoring and reporting of communications line traffic information of claim 36, further comprising:
reporting the most utilized communications lines of the switch during peak periods of utilization; and
reporting the most utilized communications lines of the switch on a current basis.

40. The method for monitoring and reporting of communications line traffic information of claim 39, wherein the number of communications lines reported as most utilized during peak periods is about twenty.

41. The method for monitoring and reporting of communications line traffic information of claim 39, wherein the reporting of the most utilized lines during peak periods is done by publishing at a web site.

42. The method for monitoring and reporting of communications line traffic information of claim 39, wherein the reporting of the most utilized lines during peak periods is done by publishing an e-mail message to the subscriber at predetermined time periods.

43. The method for monitoring and reporting of communications line traffic information of claim 39, wherein the reporting of the most utilized lines during peak periods is done by responding with an e-mail message to a subscriber demand for a list of the most utilized lines.
